(19) United States
(12) Patent Application Publication
(10) Pub. No.: US 2005/0059272 A1
(43) Pub. Date: Mar. 17, 2005

(54) Electrical connector having improved contacts

(76) Inventor: Chi Zhang, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/940,386

(22) Filed: Sep. 13, 2004

(30) Foreign Application Priority Data
Sep. 11, 2003 (CN) 03278514.3

(51) Int. Cl. H01R 12/00

(52) U.S. Cl. 439/74

(57) ABSTRACT

An electrical connector (1) includes an insulative housing (10) and a number of contacts (20). The insulative housing defines a mating space (13), a number of passageways (114) communicating with the mating space, and a number of bar portions (117) each in one passageway. Each contact has a body portion (21) received in a corresponding passageway and exposed into the mating space, and a solder portion (22) extending from the body portion. The body portion defines a recess (214) receiving a corresponding bar portion for ensuring the body portion snugly abutting against the inner face of the corresponding passageway.

### BACKGROUND OF THE INVENTION

1. Field of the Invention

The present invention generally relates to an electrical connector, and particularly to a board-to-board connector for electrically connecting two separate printed circuit boards (PCBs).

2. Description of Related Art

A board-to-board electrical connector assembly generally comprises a plug and a receptacle connectors mounted on two separate PCBs, respectively, to electrically connect with the two PCBs. U.S. Pat. No. 6,379,161 (the '161 patent) discloses a receptacle connector. The receptacle connector of the '161 patent comprises an insulative housing and a plurality of contacts. The insulative housing defines a mating slot and a plurality of passageways at opposite sides of the mating slot and communicating with the mating slot. The passageways extend throughout a bottom wall of the insulative housing to thereby forming a corresponding number of through holes in the bottom wall. The contacts are received in the passageways with mating portions thereof exposed into the mating slot and with tail portions thereof retained in the through holes.

However, the through hole has a little bigger dimension than the tail portion, which is retained in the through hole, for facilitating inserting the contacts into the passageways. So, the tail portions of the contacts cannot be reliably retained in the through holes. The mating portions of the contacts are apt to move into the mating slot, thereby adversely affecting an electrical connection between the receptacle connector and a complementary plug connector.

U.S. Pat. No. 5,639,248 discloses an electrical connector assembly including a male and a female connectors. The male connector has a housing and a plurality of male terminals. The male terminals are attached to opposite side walls of the housing with their first and second catches embedded in top ends and floors, respectively, of the opposite side walls by insert molding. However, it is labourious and costly to manufacture the male connector by insert molding.

Hence, an electrical connector having improved contacts is desired.

### SUMMARY OF THE INVENTION

An object of the present invention is to provide an electrical connector having improved contacts which can be reliably retained in an insulative housing thereof.

To achieve the above object, an electrical connector in accordance with the present invention comprises an insulative housing and a plurality of contacts. The insulative housing defines a mating space, a plurality of passageways communicating with the mating space, and a plurality of bar portions each in one passageway. Each contact has a body portion received in a corresponding passageway and exposed into the mating space, and a solder portion extending from the body portion. The body portion defines a recess receiving a corresponding bar portion for ensuring the body portion snugly abutting against the inner face of the corresponding passageway.

Other objects, advantages and novel features of the invention will become more apparent from the following detailed description when taken in conjunction with the accompanying drawings.

### BRIEF DESCRIPTION OF THE DRAWINGS

FIG. 1 is a partially, cut away perspective view of an electrical connector in accordance with the present invention, with a contact used in the electrical connector being taken out;

FIG. 2 is an enlarged perspective view of the contact of FIG. 1 but taken from another aspect; and

FIG. 3 is a cross-sectional view of FIG. 1.

### DETAILED DESCRIPTION OF THE INVENTION

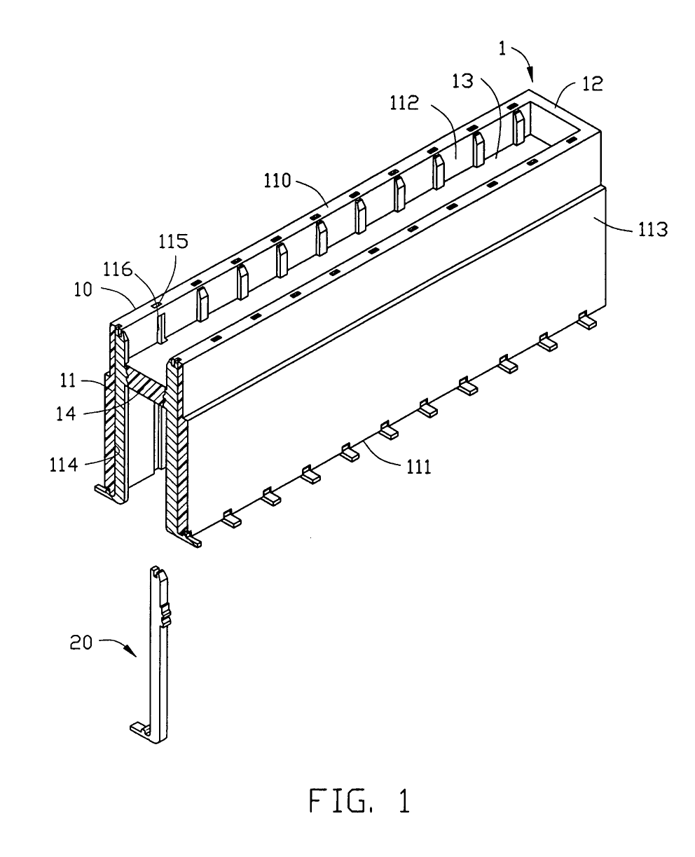

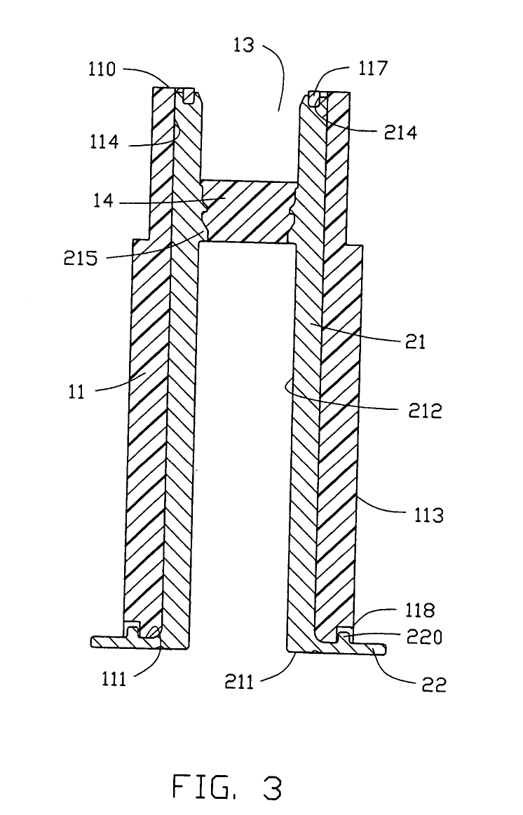

Referring to FIGS. 1 and 3, an electrical connector 1 in accordance with the present invention comprises an insulative housing 10 and a plurality of contacts 20.

The insulative housing 2 is elongated and comprises a pair of opposite sidewalls 11, and a pair of opposite end walls 12 (only one shown in FIG. 1) connecting with the sidewalls 11. A mating space 13 is formed between the sidewalls 11 and the end walls 12 for receiving a complementary connector (not shown). A bottom wall 14 is disposed in the mating space 13 and connecting with the sidewalls 11 and the end walls 12. Each sidewall 11 has a mating face 110, a mounting face 111 opposite to the mating face 110, an inner face 112, and an outer face 113 opposite to the inner face 112. Each sidewall 11 defines a plurality of passageways 114. Each passageway 114 has an aperture 115 in the mating face 110 and an opening 116 in the inner face 112 of a corresponding sidewall 11. A bar portion 117 is formed between the aperture 115 and the opening 116 of each passageway 114. The bar portions 117 extend from the mating face 110 into the passageways 114. The openings 116 extend downwardly along the inner faces 112 and penetrate through the bottom wall 14. Each sidewall 11 defines a plurality of cutouts 118 in the mounting face 111 thereof adjacent to the outer face 113 and laterally communicating with the passageways 114.

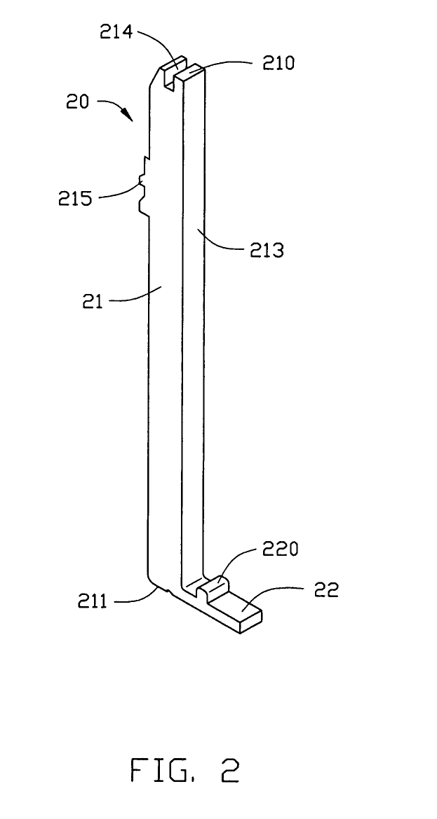

Referring to FIG. 2 in conjunction with FIG. 3, each contact 20 comprises an elongated body portion 21 and a solder portion 22. The body portion 21 has a top face 210, a bottom face 211 opposite to the top face 210, an inner face 212, and an outer face 213 opposite to the inner face 212. A recess 214 is defined in the top face 210. The body portion 21 is formed with a plurality of barbs 215 on the inner face 212. The solder portion 22 extends outwardly from a lower end of the outer face 213 of the body portion 21 and is formed with a protrusion 220 on an upper side thereof.

In assembly, the contacts 20 are inserted into the passageways 114 from the mounting face 111 with the inner faces 212 of the body portions 21 exposed into the mating space 13 to be used as contact portions for mating with contacts of the complementary connector, and with the barbs 215 engaged with the bottom wall 14 for retaining the contacts 20 in the passageways 114. The bar portions 117 are received in the recesses 214 of the contacts 20 for ensuring an upper end of the body portion 21 snugly abutting against inner faces of the passageways 114. The protrusions 220 are received in the cutouts 118 for ensuring a lower end of the body portion 21 snugly abutting against the inner faces of the passageways 114. Free ends of the solder portions 22 laterally and outwardly extend beyond the outer faces 113 of the sidewalls 11.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector comprising:
an insulative housing comprising two opposite sidewalls, two opposite end walls connecting with the two sidewalls, and a mating space formed between the sidewalls and the end walls, at least one of the sidewalls comprising a plurality of passageways communicating with the mating space and a plurality of bar portions each in one passageway; and
a plurality of contacts each comprising a body portion received in a corresponding passageway and defining a recess receiving a corresponding bar portion, and a solder portion extending from the body portion.

2. The electrical connector as claimed in claim 1, wherein each sidewall has a mating face, a mounting face opposite to the mating face, an inner face, and an outer face opposite to the inner face.

3. The electrical connector as claimed in claim 2, wherein each passageway has an aperture in the mating face and an opening in the inner face of the at least one sidewall, the bar portion being formed between the aperture and the opening and extending into the passageway from the mating face of the at least one sidewall.

4. The electrical connector as claimed in claim 2, wherein the at least one sidewall defines a cutout in the mounting face and laterally corresponding to each passageway, and wherein the solder portion of each contact is formed with a protrusion received in the cutout.

5. The electrical connector as claimed in claim 1, wherein the insulative housing comprises a bottom wall disposed in the mating space and connecting with the sidewalls and the end walls.

6. The electrical connector as claimed in claim 5, wherein the body portion of each contact is formed with a plurality of barbs engaged with the bottom wall.

7. An electrical connector comprising:
an insulative housing defining a plurality of passageways arranged in a longitudinal direction thereof, each of said passageways extending therethrough in a vertical direction perpendicular to said longitudinal direction; and
a plurality of blanking type contacts disposed in the corresponding passageways, respectively, each of said contacts defining a main plane, which is defined by said vertical direction and a lateral direction perpendicular to both said longitudinal and vertical directions, and which a whole contour of said contact lies on; wherein
both upper and lower ends of the contacts define retention devices to be respectively engaged with the housing for restricting said contact from moving in the lateral direction and upwardly in the vertical direction.

8. The electrical connector as claimed in claim 7, wherein said contact further includes retention bars in a position between said upper and lower ends.

9. The electrical connector as claimed in claim 7, wherein the retention device at the upper end defines an upward recess receiving a bar portion of the housing.

10. The electrical connector as claimed in claim 7, wherein the retention device at the lower end defines a protrusion.

11. The electrical connector as claimed in claim 10, wherein said protrusion is received in a corresponding cutout in the housing.
